(19) United States
(12) Patent Application Publication
(10) Pub. No.: US 2020/0350643 A1
(43) Pub. Date: Nov. 5, 2020

(54) GAS ABSORBER FOR LITHIUM ION BATTERY

(71) Applicant: KURITA WATER INDUSTRIES LTD., Tokyo (JP)

(72) Inventors: Jun KANEKO, Tokyo (JP); Shingo MIYAMOTO, Tokyo (JP); Mitsuru NOZUE, Tokyo (JP)

(21) Appl. No.: 16/332,943

(22) PCT Filed: Mar. 29, 2018
(86) PCT No.: PCT/JP2018/013179

§ 371 Date: Mar. 13, 2019

(30) Foreign Application Priority Data
Nov. 15, 2017 (JP) 2017-220074
Mar. 19, 2018 (JP) 2018-050776

(51) Int. Cl. H01M 10/52; H01M 10/0525

(52) U.S. Cl. CPC H01M 10/52; H01M 10/0525

(57) ABSTRACT

A lithium ion battery comprises a positive electrode terminal and a negative electrode terminal, a battery case, and an electrode body housed inside the battery case. The electrode body has a positive electrode current collector and a positive-electrode electrode plate and a negative electrode current collector and a negative-electrode electrode plate, and has a structure in which the positive-electrode electrode plate and the negative-electrode electrode plate are laminated via a separator. A carbon-based porous material in a battery case has a methane gas absorption capacity and preferably has a carbon dioxide gas absorption capacity and has a pore volume of 0.3 mL/g or less, for pores having a pore size of 4.5 Å or more. Such a gas absorber for a lithium ion battery generates no gas from reaction with an electrolytic solution of the lithium ion battery and can suitably absorb methane gas generated at the time of abnormality.

### TECHNICAL FIELD

The present invention relates to a gas absorber for a lithium ion battery suitable for absorbing methane gas generated from a lithium ion battery used in electronic equipment, automobiles, and the like.

### BACKGROUND ART

In recent years, lithium ion batteries with a large capacity and high power have been put to practical use. Since this lithium ion battery has a large capacity and high power, it is required to have higher safety and stability than conventional secondary batteries.

Regarding the typical configuration of this lithium ion battery, carbon is used for the negative electrode; a lithium transition metal oxide such as lithium cobaltate is used for the positive electrode; and a lithium salt such as lithium hexafluorophosphate (LiPF₆) blended in an organic solvent which is a non-aqueous electrolyte such as ethylene carbonate or diethyl carbonate is used as an electrolytic solution; and generally, each material of the negative electrode, the positive electrode, and the electrolyte can adopt a very large number of embodiments since only charge-discharge by moving lithium ions and exchanging charges is possible.

As the lithium salt, a fluorine complex salt such as LiBF₄, in addition to LiPF₆, and a salt such as LiN(SO₂Rf)₂.LiC(SO₂Rf)₃ (Rf=CF₃ or C₂F₅) may be used. As the lithium transition metal oxide which is the positive electrode material, LiCoO₂, LiMn₂O₄, LiNiO₂, LiFePO₄, Li₂FePO₄F, LiCO_{1/3}Ni_{1/3}Mn_{1/3}O₂, Li(LiαNixMnyCoz)O₂, and the like are known.

In the lithium ion battery using such a non-aqueous electrolytic solution, degradation and electrolysis are caused by repeated charge-discharge during long-term use of the carbonic acid ester contained in the non-aqueous electrolytic solution, overcharge, or temperature rise inside the battery at the time of abnormality such as short circuit. This generates not only CO, CO₂, and the like but also combustible gases including carbon such as methane gas inside the battery, and these generated gases increase the internal pressure, resulting in failures such as expansion of a battery package, electrolysis failure of hydrofluoric acid by trace moisture, and expansion of organic gas and vaporized water with increasing generated heat quantity.

Patent Document 1 describes a gas absorber including an A-type or LSX-type zeolite as the gas absorber provided inside such a lithium ion battery.

### PRIOR ART DOCUMENT

### Patent Document

[Patent Document 1] JP2015-162457A

### SUMMARY OF THE INVENTION

### Problems to be Solved by the Invention

However, the conventional gas absorber as described in Patent Document 1 had the problem that the ability to absorb moisture is high, for example, moisture was absorbed even in an atmosphere with a dew point of −40° C. in the dry room, and thereby the adsorption of moisture is prior to the gas absorption capacity and the absorption capacity for the gas generated from the lithium ion battery was not able to be exerted sufficiently. The use of a carbon-based material as a gas absorber has also been investigated, but the carbon-based material has adverse effect such that it causes decomposition reaction with the electrolytic solution of the lithium ion battery and tends to generate carbon dioxide gas, and thereby its application is not currently progressing.

The present invention has been made in view of the above problem, and an object of the present invention is to provide a gas absorber for a lithium ion battery wherein the absorber does not generate gas or the like from the reaction with the electrolytic solution of the lithium ion battery and is suitable for absorbing methane gas generated at the time of abnormality or the like of the lithium ion battery.

### Means for Solving the Problems

In order to solve the above problem, the present invention provides a gas absorber for a lithium ion battery, provided in the lithium ion battery and comprising a carbon-based porous material having a methane gas absorption capacity (Invention 1).

According to the above invention (Invention 1), use of a gas absorber having a methane gas absorption capacity as the gas absorber disposed in the lithium ion battery can not only absorb a flammable gas such as methane gas generated by repeated charge-discharge or the like to increase safety, but also suppress reduction of battery lifetime to hold the lithium ion battery in a stable state.

In the above invention (Invention 1), it is preferable that the carbon-based porous material has a carbon dioxide gas absorption capacity (Invention 2).

According to the above invention (Invention 2), carbon dioxide gas tends to be generated from the reaction between the electrolytic solution of the lithium ion battery and the carbon-based porous material, and further use of the absorber having a carbon dioxide gas absorption capacity can suppress battery case expansion and electrode distortion to further suppress reduction of battery lifetime.

In the above inventions (Inventions 1 and 2), it is preferable that the carbon-based porous material has a pore volume of 0.3 mL/g or less, for pores having a pore size of 4.5 Å or more (Invention 3).

According to the above invention (Invention 3), since the pores of the carbon-based porous material are usually broad, the electrolytic solution enters the inside of the pores when the pore size is large, and the amount of methane gas adsorbed or the like tends to decrease, but setting the pore volume for pores having a pore size of 4.5 Å or more to 0.3 mL/g or less can suppress entering of the electrolytic solution into the inside the pores.

In the above inventions (Inventions 1 to 3), it is preferable that the carbon-based porous material is subjected to an activation treatment with a carbon dioxide gas, nitrogen, or an argon gas (Invention 4).

According to the above invention (Invention 4), the carbon-based porous material is treated with these gases and thereby the pore size and the surface functional group of the carbon-based porous material can be adjusted.

In the above inventions (Inventions 1 to 4), it is preferable that the carbon-based porous material is finely pulverized to a particle size of 5 μm or less (Invention 5).

According to the invention (Invention 5), handling as a lithium ion battery can be excellent.

In the inventions (Inventions 1 to 5), it is preferable that the carbon-based porous material is adjusted to have a moisture content of 1% by weight or less (Invention 6).

According to the above invention (Invention 6), disposing the carbon-based porous material in a dry state having a moisture content of 1% by weight or less in a lithium ion battery can maintain the ability to absorb methane gas and carbon dioxide to quickly absorb these gases.

### Effect of the Invention

According to the present invention, use of a gas absorber having a methane gas absorption capacity as the gas absorber disposed in the lithium ion battery can not only absorb a flammable gas such as methane gas generated by repeated charge-discharge or the like to increase safety, but also suppress reduction of battery lifetime to hold the lithium ion battery in a stable state.

### BRIEF DESCRIPTION OF DRAWINGS

FIG. 1 is a cross-sectional view schematically showing the internal structure of a lithium ion battery to which a gas absorber for a lithium ion battery of the present invention can be applied.

FIG. 2 is a graph showing a moisture absorption test result of the gas absorber for a lithium ion battery in Example 1 and Comparative Example 1.

FIG. 3 is a graph showing the effect of moisture on an amount of carbon dioxide gas adsorbed of the gas absorber for a lithium ion battery in Example 1 and Comparative Example 1.

FIG. 4 is a graph showing the concentration of carbon dioxide gas after the reaction with the electrolytic solution of the gas absorber for a lithium ion battery in Example 2, Comparative Example 2, and Comparative Example 3.

FIG. 5 is a graph showing an amount of methane gas absorbed of the gas absorber for a lithium ion battery in Example 3 and Comparative Example 4.

FIG. 6 is a graph showing a change in discharge capacity in a charge-discharge cycle test of the lithium ion battery packed with the gas absorber for a lithium ion battery in Example 4 and Comparative Example 5.

FIG. 7 is a graph showing an increase in gas at high temperature storage of the lithium ion battery packed with the gas absorber for a lithium ion battery in Example 5 and Comparative Example 6.

### EMBODIMENTS FOR CARRYING OUT THE INVENTION

Hereinafter, one embodiment of the present invention will be described in detail with reference to the attached drawings.

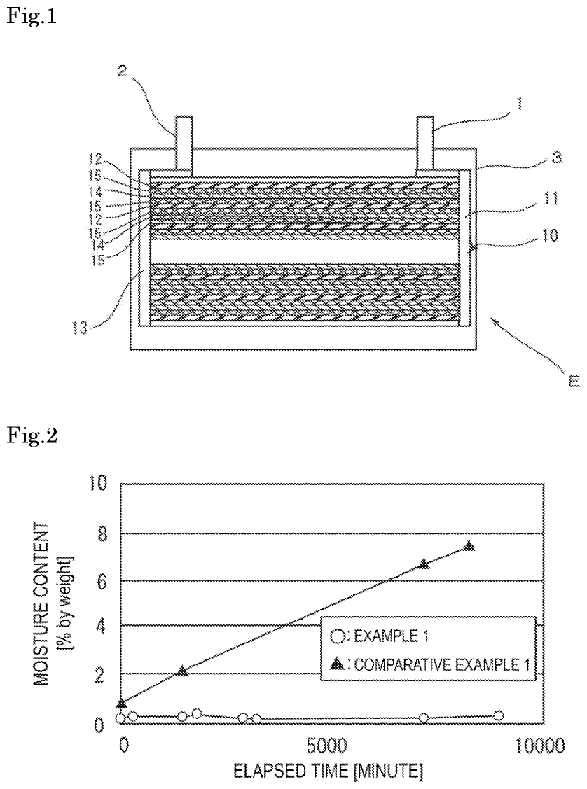

FIG. 1 is a longitudinal sectional view showing a lithium ion battery to which the gas absorber for a lithium ion battery of the present invention can be applied. In FIG. 1, the lithium ion battery E comprises a positive electrode terminal 1 and a negative electrode terminal 2; a battery case (casing) 3 which is an airtight container; and an explosion-proof valve (not shown) formed on the outer circumferential surface of the battery case 3 as required; and the electrode body 10 is housed inside the battery case 3. The electrode body 10 has a positive electrode current collector 11 and a positive-electrode electrode plate (positive electrode) 12; and a negative electrode current collector 13 and a negative-electrode electrode plate (negative electrode) 14; and has a structure in which the positive-electrode electrode plate 12 and the negative-electrode electrode plate 14 are laminated via a separator 15, respectively. The positive electrode terminal 1 is electrically connected to the positive-electrode electrode plate 12 and the negative electrode terminal 2 is electrically connected to the negative-electrode electrode plate 14. The battery case 3 as a casing is, for example, a rectangular-shaped battery tank can made of aluminum or stainless steel, and has airtightness.

The positive-electrode electrode plate 12 is a current collector in which a positive electrode mixture is held on both surfaces. For example, the current collector is an aluminum foil having a thickness of about 20 μm, and the paste-like positive electrode mixture is obtained by adding polyvinylidene fluoride as a binding material and acetylene black as a conductive material to a lithium-containing oxide of transition metal, such as LiCoO₂, LiMn₂O₄, LiFePO₄, Li₂FePO₄F, LiCO_{1/3}Ni_{1/3}Mn_{1/3}O₂, and Li(LiαNixMnyCoz)O₂, and kneading the mixture. The positive-electrode electrode plate 12 is obtained by applying this paste-like positive electrode mixture on both surfaces of the aluminum foil, followed by drying, rolling, and cutting in a band shape.

The negative-electrode electrode plate 14 is a current collector in which a negative electrode mixture is held on both surfaces. For example, the current collector is a copper foil having a thickness of 10 μm, and the paste-like negative electrode mixture is obtained by adding polyvinylidene fluoride as a binding material to graphite powder and kneading the mixture. The negative-electrode electrode plate 14 is obtained by applying this paste-like negative electrode mixture on both surfaces of the copper foil, followed by drying, rolling, and cutting in a band shape.

As the separator 15, a porous membrane is used. For example, a polyethylene-made microporous membrane can be used as the separator 15. As the non-aqueous electrolytic solution to be impregnated into the separator 15, a non-aqueous organic electrolytic solution having lithium ion conductivity is preferable, and for example, the mixed solution of a cyclic carbonate such as propylene carbonate (PC) and ethylene carbonate (EC) and a chain carbonate such as dimethyl carbonate (DMC), ethyl methyl carbonate (EMC), and diethyl carbonate (DEC) is preferable. The above non-aqueous electrolytic solution may be a solution in which a lithium salt such as lithium hexafluorophosphate is dissolved as an electrolyte, as required. For example, 1 mol/L of lithium hexafluorophosphate is added to the mixed solution obtained by mixing ethylene carbonate (EC), ethyl methyl carbonate (EMC), and dimethyl carbonate (DMC) at a ratio of 1:1:1 or the mixed solution obtained by mixing propylene carbonate (PC), ethylene carbonate (EC), and diethyl carbonate (DEC) at a ratio of 1:1:1, and thus the obtained solution can be used.

A carbon-based porous material as a gas absorber for a lithium ion battery is disposed in a battery case (casing) 3 of such a lithium ion battery E. As the carbon-based porous material in the present embodiment, activated carbon such as powdered activated carbon, granular activated carbon, fibrous activated carbon, and sheet-like activated carbon; graphite; carbon black; carbon nanotube; carbon molecular sieve; fullerene; and nanocarbon can be used.

This carbon-based porous material generally has selectivity of adsorbable molecules depending on pore size and polarity. Therefore, in addition to water and carbon dioxide, methane, ethane, ethylene, oxygen, nitrogen, and the like can be adsorbed by pore size and polarity, but in the present embodiment, the material having at least methane gas absorption capacity is used. This is because the lithium ion battery E can absorb flammable methane gas generated by repeated charge-discharge or the like to suppress reduction of battery lifetime and hold the lithium ion battery in a stable state. Further, this carbon-based porous material is preferable to have carbon dioxide gas absorption capacity. Since gas generated by repeated charge-discharge or the like is mostly carbon dioxide gas in the lithium ion battery E, absorption of this carbon dioxide gas can suppress expansion of the battery case (casing) 3, deformation of the electrode, and the like.

Specifically, since the electrolytic solution tends to enter into the inside the pores when the pore volume for pores having a pore size of 4.5 Å or more is more than 0.3 mL/g, it is preferable to use the carbon-based porous material with sharp pore size distribution such that the pore volume for pores having a pore size of 4.5 Å or more is 0.3 mL/g or less, particularly 0.2 mL/g or less. The lower limit of the pore volume for pores having a pore size of 4.5 Å or more is not particularly limited, but 0.01 mL/g or less is impractical.

The carbon-based porous material is preferable to be a material such that the surface functional group is adjusted to easily adsorb an adsorption object such as methane gas or carbon dioxide gas and to provide the polarity. Particularly, adjustment of the surface functional group to improve the hydrophobicity can improve hygroscopicity.

Adjustment of the surface functional group of the carbon-based porous material as described above can be performed by an activation treatment of the carbon-based porous material with a carbon dioxide gas, nitrogen gas, or an argon gas. Specifically, the surface of the untreated (initial state) carbon-based porous material has a carboxyl group and a phenolic hydroxyl group, and all or a part thereof can be converted to the —CH end by activation with carbon dioxide gas. The same effect can be obtained by activation with nitrogen or argon gas.

In this activation step, for example, in the case of activation with carbon dioxide gas, a carbon-based porous material is accommodated in a furnace such as a rotary kiln type; the interior of the furnace is heated to a desired activation temperature while it is in an inert atmosphere with an inert gas such as nitrogen; and then carbon dioxide gas is fed to the furnace to allow for activation treatment of the carbon-based porous material.

The activation temperature is not particularly limited, but is preferably from 350 to 1000° C., and more preferably from 800 to 950° C. Setting the temperature within this range further increases the specific surface area of the carbon-based porous material.

The treatment period (activation period) after reaching the activation temperature is preferable to be 30 minutes or more, particularly preferably 40 minutes or more, in order to increase the specific surface area of the carbon-based porous material to enhance the adsorption performance. The upper limit of the activation period is not particularly limited, but when the activation period is too long, although the pore volume increases, the pore size rather increases, and hence it is preferable to be 180 minutes or less, and particularly preferable to be 120 minutes or less.

The carbon-based porous material obtained by activation in this manner is preferable to have a surface area of 600 to 1500 m²/g, and preferably 700 to 1200 m²/g. In addition, the pore volume of the carbon-based porous material is preferable to be 0.1 to 0.5 mL/g, and particularly preferable to be 0.2 to 0.4 mL/g.

These specific surface areas, pore volumes, and average pore sizes are values measured by, for example, “BELSORP-max II” (product name) manufactured by MicrotracBell Corp.

In the present embodiment, the carbon-based porous material as described above is used as a gas absorber for a lithium ion battery, and the carbon-based porous material may be subjected to pulverization, crushing, or classification treatment as required to be powdery, granular, or the like. It can be kneaded in the positive-electrode electrode plate 12 and the negative-electrode electrode plate 14 as the electrode material of the lithium ion battery E, in particular by pulverizing it to a particle size of 5 μm or less. In addition, the carbon-based porous material can also function as a gas absorber by being present in the separator 15. In this case, the carbon-based porous material may be mixed with the material constituting the separator 15, or applying the paste of the carbon-based porous material to the surface of the separator 15 and drying it may form the layer of the carbon-based porous material on the surface of the separator 15. Furthermore, the carbon-based porous material may be laminated on one surface or both surfaces of the above separator 15 in the form of a film with a binder resin or the like.

This carbon-based porous material absorbs moisture, decreasing the absorbability of methane gas and carbon dioxide gas. In the present embodiment, it is preferable that heat treatment is performed on the carbon-based porous material to release moisture from the carbon-based porous material to pack the material in the battery case 3 with regenerating ability to absorb moisture. In this case, it is preferable to perform heat treatment so that the moisture content of the carbon-based porous material is 1% by weight or less.

Although the gas absorber for a lithium ion battery of the present invention is described with reference to the attached drawings, the present invention is not limited to the above embodiment and various modifications are possible. For example, the form of the lithium ion battery E is not particularly limited, and may be a cylindrical shape.

### EXAMPLES

The present invention will be explained in more detail based on the following specific examples, but the present invention is not limited to the following examples.

### Example 1 and Comparative Example 1

A carbon-based porous material (coconut shell activated carbon, pellet) as a raw material was accommodated in a rotary kiln type furnace, and the interior of the furnace with a nitrogen gas atmosphere was heated to 800° C. When the interior of the furnace was confirmed to reach 800° C., carbon dioxide gas was fed and treatment was performed for 120 minutes. The treated carbon-based porous material was crushed and classified so as to have an average particle size of 2.5 μm or less to obtain the gas absorber for a lithium ion battery in Example 1.

The pore volume for the pores having a pore size of 4.5 Å or more in the gas absorber for a lithium ion battery in Example 1 was 0.3 mL/g, and the carbon-based porous material had a surface area of 800 m²/g and a pore volume of 0.35 mL/g. The total acidic functional group thereof was 0 mmol/g.

[Hygroscopicity Test]

FIG. 2 shows the measurement results of the moisture concentration when 10 g of this gas absorber for a lithium ion battery was held in a dry room having a dew point temperature of −40° C. For comparison, a gas absorber for a lithium ion battery including a zeolite-based porous material (Comparative Example 1) was held in the dry room and the results of the moisture concentration measured in the same manner are also shown in FIG. 2.

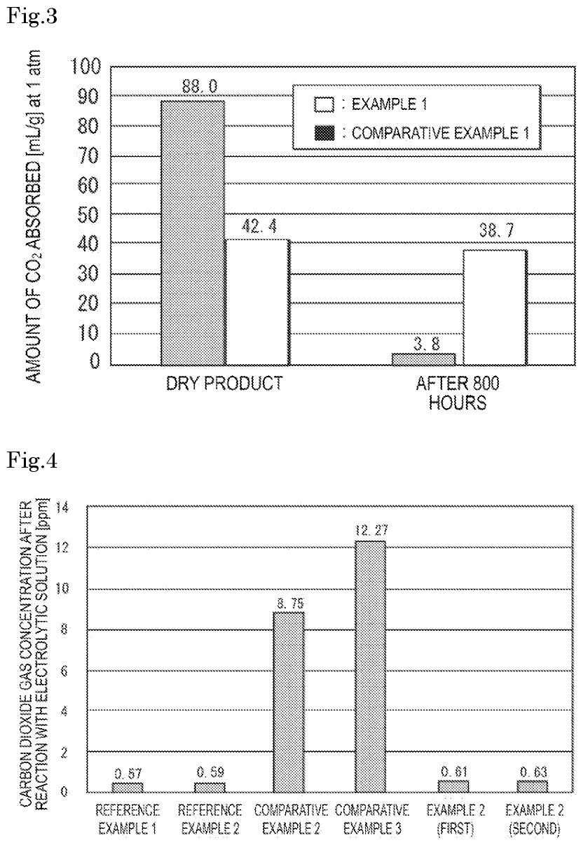

Next, the gas absorbers for the lithium ion battery in Example 1 and Comparative Example 1 after held in the dry room for 800 hours (wet state) were left in a CO₂ atmosphere, and the amount of CO₂ absorbed was measured. The results are shown in FIG. 3 together with the amount of CO₂ absorbed of the gas absorbers for the lithium ion battery in Example 1 and Comparative Example 1 in a dry state.

From FIG. 2 and FIG. 3, although the gas absorber for a lithium ion battery in Comparative Example 1 including the zeolite-based porous material in an initial state had more amount of CO₂ absorbed than the gas absorber for a lithium ion battery in Example 1, the gas absorber in Comparative Example 1 was easy to adsorb moisture to absorb moisture in the air even in a slight moisture in a dry room with a dew point temperature of −40° C., thereby significantly decreasing the amount of CO₂ absorbed. In contrast, the gas absorber for a lithium ion battery in Example 1 including a carbon-based porous material activated with carbon dioxide gas hardly absorbed moisture in the dry room, and hence there was also little fluctuation in the amount of CO₂ absorbed.

### Example 2

[Confirmation Test of Reactivity with Electrolytic Solution]

1 g of the gas absorber for a lithium ion battery used in Example 1 was charged into a commercially available electrolytic solution (1 mol/L of LiPF₆ dissolved in the electrolytic solution which was a mixture at a volume ratio of 2:4:4 of ethylene carbonate (EC):dimethyl carbonate (DMC):ethyl methyl carbonate (EMC)) of 16 mL in a nitrogen-purged 100 mL sealed container, and the amount of increase in the concentration of carbon dioxide gas generated was measured. The results are shown in FIG. 4. For comparison, the amount of increase in the concentration of carbon dioxide gas in a state where no gas absorber for a lithium ion battery was charged was measured (Reference Example 1 and Reference Example 2). The results are also shown in FIG. 4.

### Comparative Examples 2 and 3

Using two types of carbon-based porous materials (Comparative Example 2 and Comparative Example 3) not subjected to an activation treatment by a carbon dioxide gas, they were charged into the electrolytic solution in the same manner as in Example 2, and the confirmation test of reactivity with the electrolytic solution was performed. The results are also shown in FIG. 4. As the carbon-based porous material, the activated carbon (Comparative Example 2) having an average particle size of 25 μm and a pore volume of 0.38 mL/g for pores having a pore size of 4.5 Å or more, and the activated carbon (Comparative Example 3) having an average particle size of 25 μm and a pore volume of 0.40 mL/g for pores having a pore size of 4.5 Å or more were prepared.

As was apparent from FIG. 4, the carbon-based porous materials in Comparative Example 2 and Comparative Example with the non-activated carbon-based porous material having a large pore volume for pores having a pore size of 4.5 Å or more were charged into the electrolytic solution, showing a significant increase in the carbon dioxide gas concentration. This is probably because the electrolytic solution enters the inside of the pores of the carbon-based porous material and reacts with the electrolytic solution to generate carbon dioxide gas. In contrast, in Example 2 using the carbon-based porous material used in Example 1, double measurements showed a low increase in the carbon dioxide gas concentration and almost the same level as in Referential Examples 1 and 2 in which no carbon-based porous material was charged, and thus low reactivity with the electrolytic solution was confirmed.

### Example 3 and Comparative Example 4

[Confirmation Test of Methane Gas Absorption Capacity]

The amount of methane gas adsorbed with 0.2 g of the gas absorber for a lithium ion battery used in Example 1 was measured by “BELSORP-max II” (product name) manufactured by MicrotracBell Corp. The results are shown in FIG. 5. For comparison, the amount of methane gas adsorbed with the gas absorber for a lithium ion battery including the zeolite-based porous material (Comparative Example 4) was measured in the same manner. The results are also shown in FIG. 5.

As was apparent from FIG. 5, it was able to be confirmed that the amount of methane gas absorbed in Example 3 was about 5 times higher than Comparative Example using the gas absorber for a lithium ion battery including the zeolite-based porous material.

### Example 4

[Charge-Discharge Cycle Test]

The following materials were prepared as materials of the lithium ion battery for testing.

Flat cell: electrode area of about 2 cm² (Φ16 mm), manufactured by Hohsen Corp.
Positive electrode: a positive electrode material to which 2% by weight of the gas absorber for a lithium ion battery used in Example 1 was added
Negative electrode: Natural graphite
Separator: PP separator having a thickness of 20 μm
Electrolyte solution: 1% by weight of VC and 1 mmol/L of LiPF₆ dissolved in a mixed solution of ethylene carbonate
(EC):ethyl methyl carbonate (EMC)=3:7

The positive electrode, the negative electrode, and the separator were dried under reduced pressure at 90° C. for 1 hour or more by a glass tube oven. These materials were assembled in a glove box under an argon gas atmosphere at a dew point of −30° C. or less to prepare a lithium ion battery material for testing.

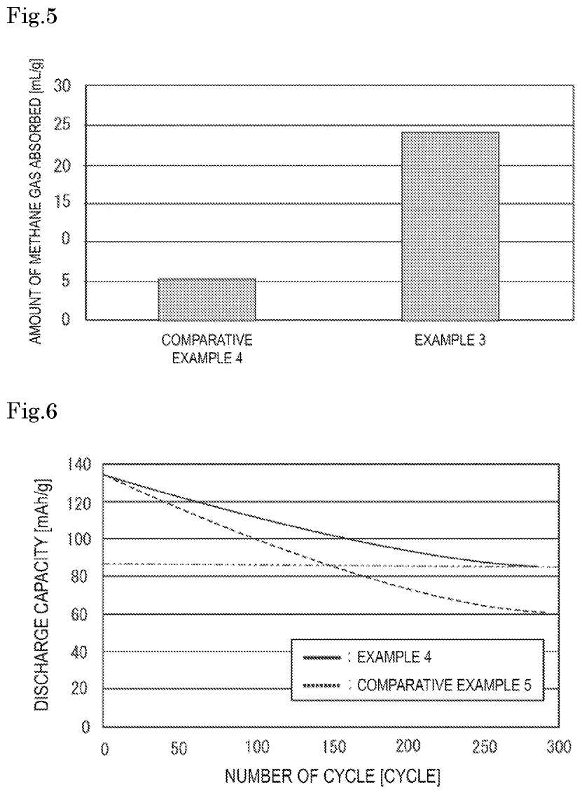

This lithium ion battery was connected to a charge-discharge test unit (charge-discharge battery test system PFX2011, manufactured by KIKUSUI ELECTRONICS CORPORATION), and charge-discharge cycles were repeated 300 times under the condition of charge amperage of 1.0 C, constant-voltage charge of 4.2 V×60 minutes and discharge amperage of 1.0 C, discharge cut-off voltage of 3.0 V, and 25° C. to measure the change in discharge capacity. The results are shown in FIG. 6.

### Comparative Example 5

A lithium ion battery material for testing was prepared in the same manner as except that the gas absorber for a lithium ion battery was not added to the positive electrode in Example 4.

This lithium ion battery was connected to a charge-discharge test unit, and the change in discharge capacity was measured by charge-discharge test under the same condition as in Example 4. The results are also shown in FIG. 6.

As was apparent from FIG. 6, Example 4 in which the gas absorber for a lithium ion battery used in Example 1 was added to the positive electrode and Comparative Example 5 without the addition allowed to double the period until the discharge capacity is reduced by ⅓, confirming extended lifetime effect of battery lifetime.

### Example 5

[High Temperature Storage Test]

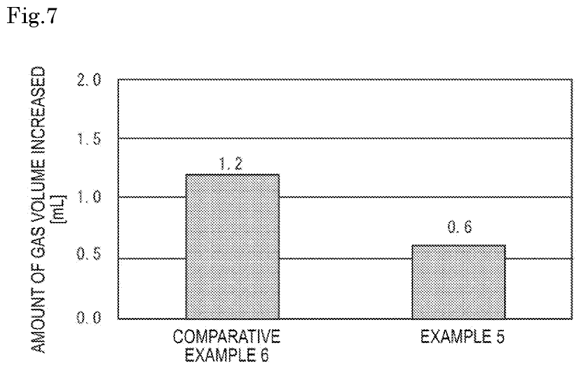

The amount of gas generated (amount of gas volume increased) inside the battery after 85° C. for 7 hour storage of the lithium ion battery for testing manufactured in Example 4. The results are shown in FIG. 7.

### Comparative Example 6

The amount of gas generated (amount of gas volume increased) inside the battery after 85° C. for 7 hour storage of the lithium ion battery for testing manufactured in Comparative Example 5. The results are also shown in FIG. 7.

As is apparent from FIG. 7, it is confirmed that in Example 5 in which the gas absorber for a lithium ion battery used in Example 1 was added to the positive electrode, the amount of gas volume increased was 0.6 mL against 1.2 mL in Comparative Example 6 in which no gas absorber for a lithium ion battery was added and thus the amount of gas generated was able to be reduced to about 50 volume %.

### DESCRIPTION OF REFERENCE NUMERALS

1 Positive electrode terminal
2 Negative electrode terminal
3 Battery case (casing)
10 Electrode body
11 Positive electrode current collector
12 Positive-electrode electrode plate
13 Negative electrode current collector
14 Negative-electrode electrode plate
15 Separator
E Lithium ion battery

1. A gas absorber for a lithium ion battery, provided in the lithium ion battery and comprising a carbon-based porous material having a methane gas absorption capacity.

2. The gas absorber for a lithium ion battery according to claim 1, wherein the carbon-based porous material has a carbon dioxide gas absorption capacity.

3. The gas absorber for a lithium ion battery according to claim 1, wherein the carbon-based porous material has a pore volume of 0.3 mL/g or less, for pores having a pore size of 4.5 Å or more.

4. The gas absorber for a lithium ion battery according to claim 1, wherein the carbon-based porous material is subjected to an activation treatment with a carbon dioxide gas, nitrogen, or an argon gas.

5. The gas absorber for a lithium ion battery according to claim 1, wherein the carbon-based porous material is finely pulverized to a particle size of 5 μm or less.

6. The gas absorber for a lithium ion battery according to claim 1, wherein the carbon-based porous material is adjusted to have a moisture content of 1% by weight or less.
